(19) United States
(12) Patent Application Publication
(10) Pub. No.: US 2006/0179708 A1
(43) Pub. Date: Aug. 17, 2006

(54) Flying insect management system

(76) Inventor: Akhil Demian Garland, Harrisville, NH (US)

Correspondence Address: Akhil D. Garland, 279 Cobb Hill Road, PO Box 134, Harrisville, NH, 03450, US

(21) Appl. No.: 11/059,735

(22) Filed: Feb. 17, 2005

(51) Int. Cl. A01M 1/02; A01M 1/08

(52) U.S. Cl. 43/107; 43/132.1; 43/113; 43/139

(57) ABSTRACT

An integrated system to reduce the entry of flying insects into a predefined area; the system includes a plurality of insect management devices that can act as flying insect traps or flying insect repellants that are controlled either remotely via radio signals or through wires, by a micro controller that utilizes several environmental variables such as current wind speed, wind direction, rainfall, humidity, and other variables to then control the release and/or generation of attractants and/or repellents only to selected insect management devices around the predetermined area to be protected. Insect attractant and/or repellant is pumped underground from a central source to selected insect management devices.

### BACKGROUND OF THE INVENTION

1. Field of the Invention

This invention relates to controlling flying insects.

2. Description of Prior Art

Flying insects have been bothering mankind since the beginning of time. Blood sucking biting insects are well known for wrecking outdoor picnics, ruining cocktail hours and sunsets, distracting golfers, driving gardeners indoors for protection, preventing homeowners from enjoying their pool or patio, and have in fact successfully created their own season in many areas of the world, widely known as “bug season.” But beyond the many inconveniences of biting insects are perilous dangers—biting insects are responsible for over one million deaths worldwide each year. Non-biting flying insects, such as house flies, fruit flies, etc. are also an annoyance and are known to carry and transmit diseases.

While blanket, indiscriminate spraying of deadly poisons has been the method of choice for flying insect control for several decades, various contraptions have been developed over time to try and help manage flying insects (mosquitoes, black flies, gnats, horseflies, no-seeums, houseflies, etc) without the need for harmful pesticides. However none of these non-poisonous methods has been truly efficient and effective. For example electronic bug killing systems with ultraviolet light attraction sources have been proven effective at attracting and electrocuting non-biting flying insects such as moths, but have been proven ineffective at attracting and destroying biting insects.

Carbon-dioxide baited biting insect traps have been in use for decades, first as research tools and monitoring apparatuses to assist in insecticide-based mosquito control planning, and more recently commercially sold as traps that can be placed in a yard or near an area to be protected. It is well known that biting insects are attracted to Carbon Dioxide and that they navigate upwind towards a source of CO2 in search of a host. CO2 baited traps are generally operated as stand-alone traps, and while they often do catch biting insects, they are usually ineffective due to the fact that there is an overwhelming population (often hundreds of thousands) of biting insects in the vicinity to be protected and a stand-alone trap can only clear a small area down-wind of where the trap has been placed.

The idea of creating a barrier by placing traps or attractants around the perimeter of a predefined area has been around for hundreds of years, dating back to the primitive use of cows and other animals as barriers around a house or small village. Prior art has taught us that placing fly traps, yellow jacket traps, and other biting or stinging insect traps around the perimeter of an area to be protected can be effective as it not only creates a barrier preventing flying insects from crossing into the predetermined area to be protected but also draws insects that are within the protected area out to the perimeter and away from gathering humans and pets.

U.S. Pat. No. 5,813,166 (Wigton et. Al) teaches a perimeter-based flying insect trapping system in which a plurality of traps are placed around a continuous perimeter of a predefined area, said plurality of traps cooperating to create barrier to reduce the amount of biting insects within said predetermined area to be protected inside the perimeter. This trapping system further comprises a controller that, based on temperature and time, releases pulses of CO2 gas from a liquid CO2 cylinder through a solenoid valve to said traps placed around the continuous perimeter, said traps also baited with a slow, continuous release of Octenol, also a known biting insect attractant. While this arguably is the most effective non-poisonous biting insect control method to date, it is inefficient in that it requires an enormous supply of CO2 as the traps all operate simultaneously and also does not take many other factors that affect the ability of insects to pester and bite such as rainfall, wind velocity, wind direction, humidity and barometric pressure. By not taking rainfall, wind velocity, wind direction, humidity and barometric pressure into consideration, these former systems are expensive to operate and inefficient, as they run during times when flying insects are not active, such as during a rain or extremely windy conditions.

### BRIEF SUMMARY OF THE INVENTION

This instant invention comprises a sophisticated system of insect management devices, managed by a micro controller that uses one or more environmental variables, including but not limited to current wind speed, wind direction, rainfall, humidity, barometric pressure to determine whether or not to generate and release attractants and/or repellants into selected insect management devices. As it is expensive to generate and release attractants such as Carbon Dioxide or repellants, this system only releases attractants or repellants in the insect management devices that are in a selected position in the predetermined area to be protected, such as up-wind or down-wind, thereby dramatically increasing the efficiency and effectiveness of the system over any prior systems.
a. It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims.

### DETAILED DESCRIPTION OF THE PREFERRED EMBODIMENTS

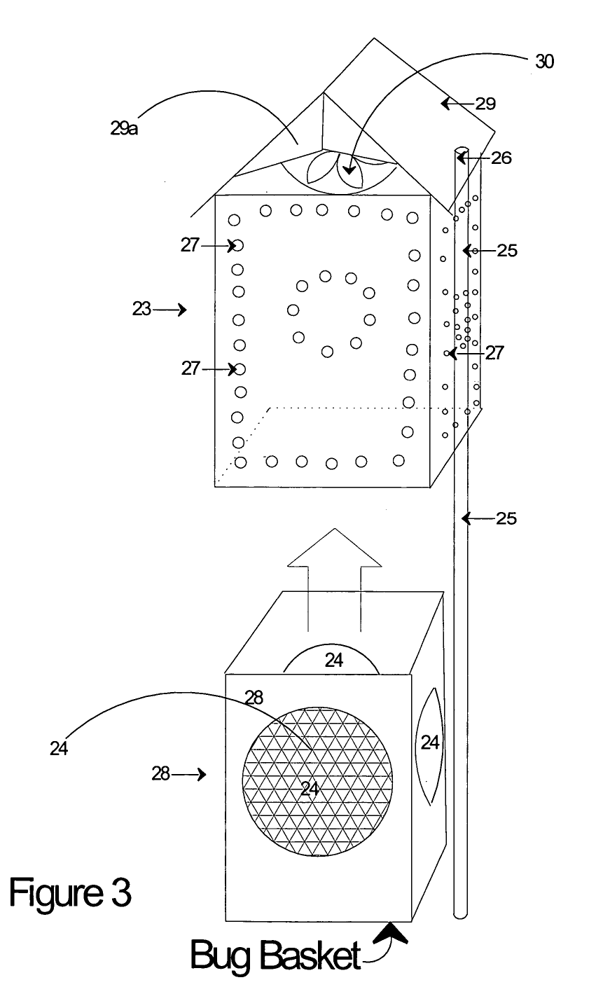

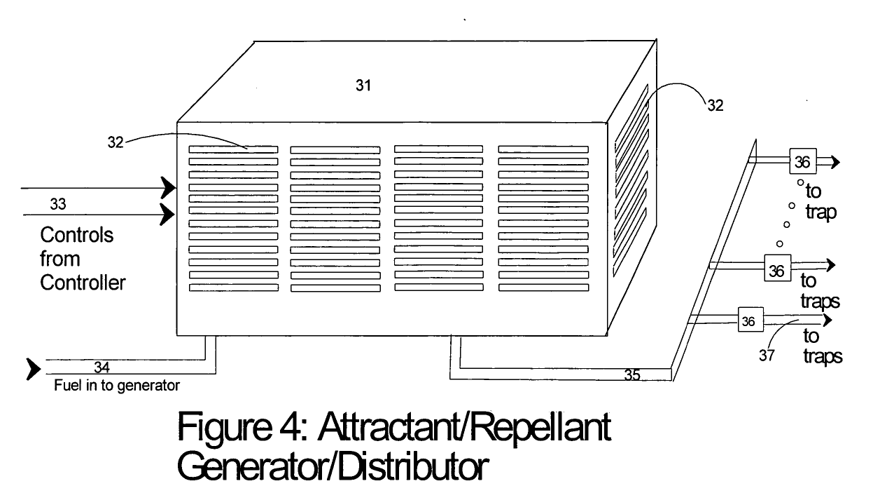

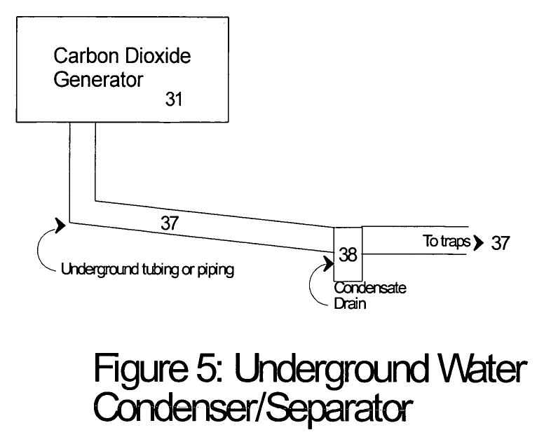

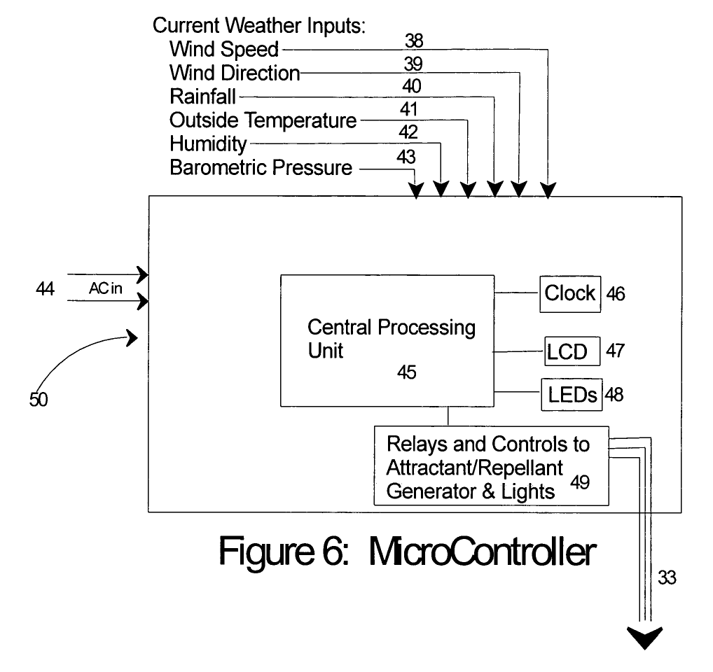

A micro controller 50, FIG. 6, receives environmental or other relevant data 38-43 (either wirelessly or via wire), including current wind speed 38, wind direction 39, rainfall 40, outside temperature 41, humidity 42, barometric pressure 43, and delivers an attractant or a repellent generated by the attractant/repellant generator in FIG. 4. Many biting insects, for example, will roost and are unlikely to feed in the event that the ambient air does not contain enough moisture, as it will dehydrate their wings and body. Many biting insects cannot fly in high wind conditions and are unable to feed on or pester humans. Many flying insects cannot fly if it is raining. Biting insects are much more active before an approaching storm, when the barometric pressure is falling quickly. Environmental conditions are ever changing, so this instant invention monitors these ever changing conditions and operates the system according to the inputs it receives. The attractant or repellant is then pumped through underground piping or tubing 37 to the upwind and downwind insect management devices 23 around the area to be protected. Insect management devices 23 can serve either as traps that attract and capture flying insects in the event that an attractant is delivered to protect a predetermined area 12, or as flying insect repellants in the event that a repellant is delivered to protect said predetermined area 12. While the system is running, some selected insect management devices can be acting as attractants and traps, while other selected insect management devices can be simultaneously acting as repellant devices. Tubing and wiring is expensive, so the underground tubing and wiring can be arranged in a horseshoe pattern from the controller and attractant and repellant generator in order to reduce the total amount of tubing and wiring needed. The micro controller 50 has an LCD display 47 to output current conditions and assist in user programming. The micro controller also powers many LEDs 48 on its faceplate that inform the user of the current status of the system. In addition the micro controller 50 can read sensors, such as optical sensors, placed at traps to count the number of flying insects that have entered each trap, offering individual and system totals of flying insects caught. It is also contemplated that the micro controller could be located at a centralized service provider within a nearby town or as remote as another state or country, and specific controlling commands could be sent wirelessly via satellite, paging network, or other radio frequencies to this system.

It is well known that flying insects are attracted to a variety of attractants. Biting insects, such as mosquitoes, black flies, horseflies, gnats and no-see-ums are attracted to Carbon Dioxide, Octenol and other attractants. Many non-biting flies such as fruit flies and house flies are attracted to decaying matter. Flies navigate upwind towards the origin of a particular scent or attractant. This instant invention delivers the attractant or repellant only to selected insect management devices, such as those that are upwind or downwind of the area to be protected, nearly doubling the efficiency of the system. Said insect management devices may act as an attractant, an attractant with a trap, or a repellant.

In the case that an attractant is to be delivered to the selected insect management devices, propane or carbon-based fuel is combusted, as an open flame, in a burn chamber 5 to generate CO2 gas. Many systems use catalytic, non-flame combustion of CO2 to generate the CO2 gas at a lower temperature, but this instant invention uses an open flame, as it is easier to turn off and on in instances where large amounts of CO2 need to be generated. The hot CO2 gas is then cooled in a heat exchanger 1, by flowing it through metal piping and removing the heat with a fan 2 which receives airflow 10 from air outside the generator housing. The CO2 is cooled to a temperature below 200 degrees F. so it can then be mixed with additional fresh air until it is cooled down to below 146 degrees F. and then can be compressed with a compressor or blower 3 and pumped towards and delivered to the traps 23. After the CO2 gas passes through the compressor 3 it enters a mixing chamber 4, where it can be mixed with additional attractants, such as lactic acid or Octenol. Water can be a problem in the underground tubing and is undesirable, so the condensate that forms on the walls of the tubing needs to be removed. After the attractant exits the compressor and mixing chamber it is further cooled geo-thermally in the tubing 37 as it passes through the earth. This cooling allows the water to condensate on the walls of the tubing, where it can then be drained out in a solenoid-activated condensate drain valve 38 periodically, such as after each cycle.

In the case that an attractant is delivered to the selected insect management devices, flying insects are attracted to the attractant, sucked into traps 23 via fan 30 and trapped in a bug basket 28, which is a plastic container with large holes covered in a fine mesh netting 24 so flying insects cannot escape. Because of the force of air pushing through the fan 30, flying insects are trapped in the bug basket 28 where they dehydrate and expire. Bug baskets 28 slide up into the traps 23 and snap into place for convenient removal and reattachment. Traps have holes in the side 27 to allow for increased airflow and suction from the fan, a pitched roof 29 to shed snow and precipitation, angled insect and air deflectors 29a that are designed to deflect flying insects that accidentally bump into them down towards the fan 30.

In the case that a repellant is delivered to the selected insect management devices, the repellant exits the supporting pipe 25 in the vicinity of the top of the pipe 26, and flying insects are repelled away from the area and discouraged from entering the protected area 12.

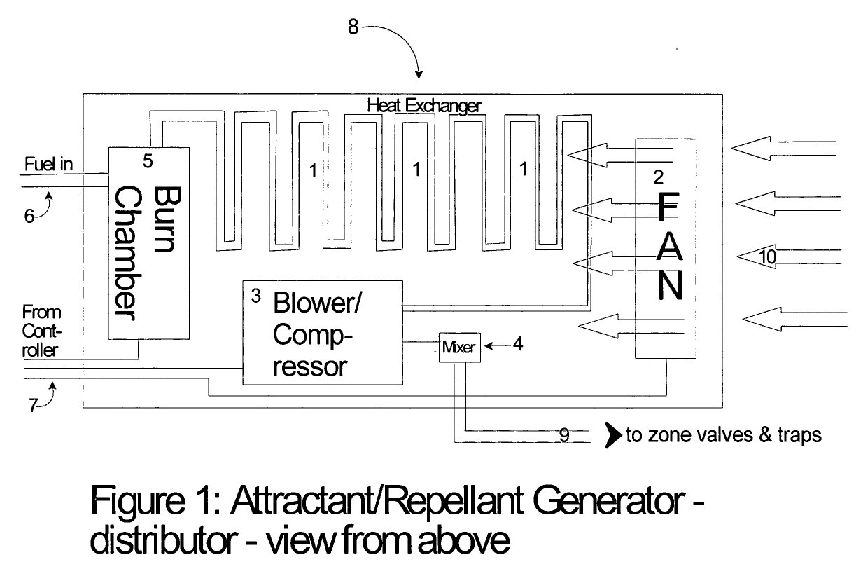

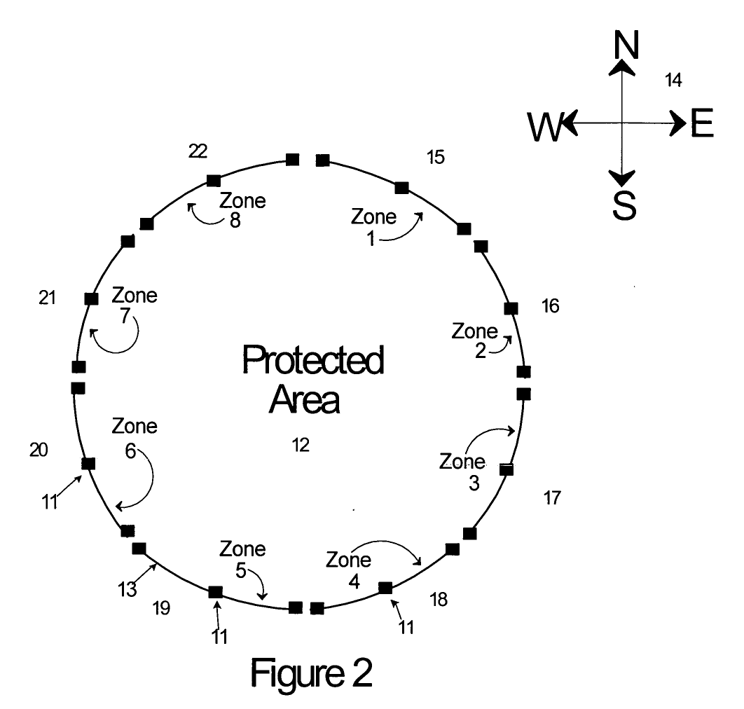

By selectively activating specific insect management devices, such as that are upwind or downwind from the area to be protected, this instant invention nearly doubles the efficiency and power as compared to prior art systems that used a set of active traps placed around the continuous perimeter of a predefined area. For example, if the wind were coming from the North (see FIG. 2), only “zone 8” 22, “zone 1” 15, “zone 5” 19, and/or “zone 4” 11 could be activated by the micro controller 50. If the wind were to later change and come from the East, only “zone 2” 16, “zone 3” 17, “zone 7” 21, and “zone 6” 20 could be activated. Furthermore, if the wind were to come from the North East, “zone 1” 15, “zone 2” 16, “zone 6” 20 and “zone 5” 19 could be activated. Since wind directions can at times change quickly and unexpectedly, this system averages wind directions over a predetermined period of time of, for example 15 minutes, and activates zones accordingly. Zones are controlled by solenoid zone valves 26 which are themselves controlled by the micro controller 50. Activated zones can receive either an attractant or a repellant, even simultaneously, depending on weather conditions and user-selectable programming.

Most insect traps currently sold today are extremely unattractive to look at. The traps 23 are designed to look like beautiful landscape lanterns supported on an elegant post. They have a light bulb inside, air holes 27 around the side to both allow for increased suction into the trap as well as provide a beautiful lantern look. The support pole 25 serves as a conduit to deliver the attractant and/or repellant as well as hide the electrical wires that power the suction fan 30 and interior light. Sufficient space (at least 0.25 inches) is left between the bug basket 28 and the outer trap housing such that adequate air may exhaust without restricting the airflow and reducing the suction and effectiveness of the trap.

As mentioned above, the present invention is not intended to be limited to a system or method which must satisfy one or more of any stated or implied object or feature of the invention and should not be limited to the preferred, exemplary, or primary embodiment(s) described herein. Modifications and substitutions by one of ordinary skill in the art are considered to be within the scope of the present invention, which is not to be limited except by the following claims.

1. A flying insect management system, comprising:
a plurality of insect management devices placed generally around the perimeter of a predetermined area to be protected;
at least one environmental sensor, for sensing an environmental condition; and
a system controller, coupled to said plurality of insect management devices and responsive to said at least one environmental sensor, for activating one or more selected insect management devices based on a sensed environmental condition.

2. The management system according to claim 1 wherein said plurality of insect management devices are selected from the group consisting of insect attractant devices, insect attracting and trapping devices, and insect repellent devices.

3. The management system according to claim 1 wherein said environmental condition is selected from the group consisting of wind speed, wind direction, rainfall, humidity.

4. The management system according to claim 3 wherein said system includes two or more environmental sensors, at least one of which is selected from the group consisting of a wind speed and wind direction sensor.

5. The management system according to claim 3, wherein the system controller utilizes a humidity environmental condition to activate one or more of said insect management devices that are up wind or downwind of an area to be protected in the event that said humidity condition is greater than approximately 20%.

6. The management system according to claim 3, wherein the system controller utilizes a barometric pressure environmental condition to activate one or more of said insect management devices that are upwind or down wind of an area to be protected in the event that said barometric pressure drops quickly.

7. the management system according to claim 3, wherein the system controller utilizes current rainfall environmental information to activate one or more of said insect management devices that are upwind or downwind of an area to be protected in the event that it is not raining outside.

8. the management system of claim 1, wherein said system controller releases one of an insect repellent and an insect attractant to selected insect management devices of said plurality of insect management devices.

9. The management system according to claim 3, wherein the system controller utilizes a current wind direction environmental condition to activate one or more of said insect management devices that are upwind or down wind of an area to be protected.

10. The management system according to claim 9 wherein said activated insect management devices release a repellant.

11. The management system according to claim 3, wherein the system controller utilizes a current wind direction environmental condition to activate one or more of said insect management devices that are upwind or down wind of an area to be protected in the event that the system controller computes that the recent average wind speed is less than 11 mph.

12. the management system of claim 2, wherein said insect attractant device releases carbon dioxide as an insect attractant, and wherein in said carbon dioxide is generated using an open flame.

13. the management system of claim 12, wherein said system further comprises a heat exchanger that cools the generated carbon dioxide to below 200 degrees Fahrenheit so that it may be pumped through a compressor or blower to be distributed to insect management devices.

14. the management system of claim 12 wherein said management system mixes fresh, cool air with the generated carbon dioxide to reduce the temperature to below 146 degrees Fahrenheit so that it may be pumped through a compressor or blower to be distributed to insect traps.

15. The management system of claim 12 further comprising a mixing chamber that mixes additional attractants, such as Octenol, into the carbon dioxide, into the generated attractant to be distributed to the insect management devices.

16. The management system of claim 12 that further uses the ground or earth as a secondary geothermal cooler to promote the condensation of water which then can be drained out of the underground tubing system feeding the insect management devices.

17. the management system of claim 1, wherein said management system controller may be controlled from a centralized location.

18. the management system of claim 17, wherein said centralized location is remote from said insect management devices, and wherein said management system is controlled by a means selected from the group consisting of a satellite signal, a pager signal and radio frequency signal.

19. the management system of claim 1, wherein said plurality of insect management devices are arranged in a horseshoe pattern, and wherein said system includes a source of the insect attractant or insect repellent located at or near the midpoint of the horse shoe pattern, thereby reducing the distance that said insect attractant or insect repellent must be delivered to the insect management devices.

20. A flying insect management system, comprising:
at least one insect management device, adapted to be located in or around an area to be protected against insects, said at least one insect management device including:
a light source, coupled to a light source controller, for controlling an on and off condition of said light source, said light source, when in said on condition, for attracting insects to said insect management device and for providing a source of localized ambient light; and
an insect management delivery element, coupled to a system controller and to a source of insect management medium, for delivering, under control of said system controller, said insect management medium; and
a system controller, coupled to said at least one insect management device and including said light source controller, for controlling said on and off condition of said light source, and for controlling delivery of said insect management medium to said insect management delivery element of said at least one insect management device.

21. The flying insect management system of claim 20 wherein said insect management medium is selected from the group consisting of an insect attractant and an insect repellent.

22. The flying insect management system of claim 21 further including a plurality of insect management devices located in or around an area to be protected against insects.

23. The flying insect management system of claim 22 wherein said system controller controls whether any one or more of said plurality of insect management devices delivers said insect attractant or said insect repellent.

24. The flying insect management system of claim 20 wherein said system controller is responsive to said at least one environmental sensor, for activating one or more selected insect management devices based on a sensed environmental condition.

25. The flying insect management system of claim 20 wherein said insect management device further includes an insect trapping device, for trapping flying insects.

26. The flying insect management system of claim 25, wherein said insect trapping device includes a suction fan and a deflector shield, said deflector shield for deflecting flying insects towards said suction fan.

27. The flying insect management system of claim 26, wherein said insect trapping device further includes an insect collection device, located proximate an output region of said suction fan, for collecting flying insects.

28. the management system of claim 2, wherein selected one or more of said plurality of insect management devices deliver a flying insect repellent while generally simultaneously a selected one or more of said plurality of insect management devices deliver a flying insect attractant.

29. the management system according to claim 1, wherein said insect management devices further including sensor to count the number of flying insects entering each said insect management device.

30. A method of providing a flying insect management system, comprising:
Placing a plurality of insect management devices generally around the perimeter of a predetermined area to be protected;
providing at least one environmental sensor, for sensing an environmental condition; and
providing a system controller, coupled to said plurality of insect management devices and responsive to said at least one environmental sensor, for activating one or more selected insect management devices based on a sensed environmental condition.
